(19) United States
(12) Patent Application Publication
(10) Pub. No.: US 2012/0168006 A1
(43) Pub. Date: Jul. 5, 2012

(54) RESERVOIR FOR FUEL TANK

(75) Inventors: Moon SUHWAN, Jeongeup-si (KR); Chanheum YOON, Yeongi-gun (KR)

(73) Assignee: COAVIS, Yeongi-gun (KR)

(21) Appl. No.: 13/337,663

(22) Filed: Dec. 27, 2011

(30) Foreign Application Priority Data
Dec. 30, 2010 (KR) 10-2010-0138404

(51) Int. Cl. F15C 3/00

(52) U.S. Cl. 137/544

(57) ABSTRACT

Provided is a reservoir for a fuel tank capable of being easily maintained by effectively preventing foreign materials in fuel from being introduced into a pump of a fuel transferring pipe.

### CROSS-REFERENCE TO RELATED APPLICATIONS

This application claims priority under 35 U.S.C. §119 to Korean Patent Application No. 2010-0138404, filed on Dec. 30, 2010, in the Korean Intellectual Property Office, the disclosure of which is incorporated herein by reference in its entirety.

### TECHNICAL FIELD

The present invention relates to a reservoir for a fuel tank.

Fuel should be continuously and stably supplied from a fuel tank of a vehicle to an engine. Therefore, a number of technologies for allowing fuel to be smoothly and stably supplied to an engine by a desired amount have been disclosed. Particularly, in the case in which a driving condition is not a general driving condition, that is, in the case in which the driving condition is not a condition in which fuel is appropriately filled in a fuel tank and a vehicle itself is being driven, a technology of allowing the fuel to be smoothly and stably supplied as described above is very important. Particularly, in the case in which the vehicle has just started or the fuel is not sufficiently filled in the fuel tank, it is difficult to smoothly supply the fuel to the engine only with a fuel supply structure in the general driving condition. Therefore, the fuel tank is generally provided with a reservoir, which is a structure allowing the fuel to be smoothly supplied in this case.

The reservoir, which has a form of a small fuel receiver provided in a fuel supply pipe connected to a fuel tank, is designed to always receive a predetermined amount or more of fuel regardless of an amount of fuel received in the fuel tank. Therefore, even in the case in which the amount of the fuel received in the fuel tank is significantly small or a fuel surface in the fuel tank becomes an abnormal state such as a case in which the vehicle is driven on a steep road for a long period of time, or the like, the fuel may be stably supplied to the engine by the reservoir.

### BACKGROUND

FIG. 1 schematically shows a structure of a general reservoir. Generally, the reservoir 100′ is provided in a fuel tank 300′ and is basically configured to include: a receiving part 110′ having a fuel transferring pipe 120′ connected thereto and receiving fuel, the fuel transferring pipe 120′ transferring the fuel to an engine 200′; a pump 130′ provided in the fuel transferring pipe 120′ to transfer the fuel received in the receiving part 110′ to the engine 200′; a supplying part 140′ connected to the receiving part 110′ to supply the fuel in the fuel tank 300′ into the receiving part 110′; and a measuring part 150′ measuring an amount of the fuel received in the receiving part 110′.

The supplying part 140′ has a form of a jet pump. The number of jet pumps may be one or more according to a form, a structure, and the like, of the fuel tank 300′. The measuring part 150′ generally has a form of a float, which is one of the simplest structures measuring a water level. In addition, although not shown, the reservoir 100′ is also provided with a structure to which a return fuel discharge pipe discharging fuel returned from the engine 200′ into the receiving part 110′ of the reservoir 100′ is connected, in addition to the above-mentioned components. In addition, in the case in which the supplying part 140 has the form of the jet pump, the reservoir 100′ further includes a structure supplying a portion of fuel from the pump 130′ to the supplying part 140′ to allow a jet pump operation to be smoothly performed in the supplying part 140.

Meanwhile, generally, gasoline, diesel, and the like, have been widely used as fuel of a vehicle. In addition, biodiesel, or the like, has also been used. The fuel is generally subjected to an operation of removing foreign materials therein by being filtered during a process in which it is commercialized. However, it is difficult to completely remove the foreign materials, such that the foreign materials may often be actually intruded into the fuel. In addition, the diesel is solidified at a more rapid speed as compared to the gasoline, due to characteristics thereof, as a temperature decreases. Further, since the diesel contains relatively much moisture due to characteristics of a production process thereof, the diesel may also include a lump generated due to the freezing of the moisture in the fuel particularly in a low temperature environment.

Here, in the case in which fuel having foreign material intruded thereinto or having a lump generated due to freezing or solidification of moisture therein is introduced into the reservoir, there is the possibility that the foreign material, the fuel itself, the solidification material generated due to the freezing of the moisture included in the fuel, or the like, will be caught in a sucking part of the pump operated in order to supply the fuel in the reservoir to the engine through the fuel transferring pipe. When the foreign materials are caught in the pump, the fuel is not smoothly sucked into the fuel transferring pipe, such that the fuel is poorly supplied to the engine.

In order to solve this problem according to the related art, a structure as shown in FIG. 2 has been disclosed. FIG. 2A shows a foreign material removing structure of a fuel pump disclosed in Korean Patent Registration No. 0898217 (hereinafter, referred to as the related art 1). The related art 1 has disclosed the foreign material removing structure of a fuel pump configured to include a reservoir cup including a fuel introducing part so that fuel in a fuel tank is introduced by pressure of fuel returned from an engine; a check valve installed at the fuel introducing part side in the reservoir cup; a pre-filter preventing foreign materials included in the fuel in the fuel tank from being introduced into the reservoir cup; and an opening and closing device closing the check valve when an amount of the fuel in the reservoir cup is a reference value or more and opening the check valve when the amount of the fuel in the reservoir cup is less than the reference value. In addition, FIG. 2B shows a reservoir cup structure of a vehicle fuel tank disclosed in Korean Patent Laid-Open No. 1998-0060428 (hereinafter, referred to as the related art 2). The related art 2 discloses the reservoir cup structure of a vehicle fuel tank configured to include a reservoir cup included in a fuel tank; a plurality of auxiliary reservoir rooms installed in the reservoir cup and having an outlet formed at one side position of an upper side portion thereof; and a return pipe branched at the center thereof so that fuel returned from an engine is returned to each of the reservoir cup and the plurality of auxiliary reservoir rooms.

In the related art 1 and the related art 2, as shown in FIGS. 2A and 2B, a filter (a reference numeral 30 of FIG. 2A and a reference numeral 54 of FIG. 2B) is included in a sucking part position of a pump, thereby making it possible to filter foreign materials included in fuel introduced into the pump.

However, in the case of the filter included directly in the pump, since the filter is included in the sucking part position of the pump as shown in FIGS. 2A and 2B, when the foreign materials are accumulated, it is difficult to clean or replace the filter. In addition, when the foreign materials are accumulated, it is difficult for the pump to suck the fuel, such that the fuel may not be still supplied smoothly. In order to solve this problem, the filter should be replaced or cleaned. However, a large amount of time and cost are required to replace and clean the filter due to structural characteristics thereof as described above.

### SUMMARY

An embodiment of the present invention is directed to providing a reservoir for a fuel tank capable of being easily maintained by effectively preventing foreign materials in fuel from being introduced into a pump of a fuel transferring pipe.

In one general aspect, a reservoir 100 for a fuel tank 300 includes: a receiving part 110 having a fuel transferring pipe 120 connected thereto and receiving fuel, the fuel transferring pipe 120 transferring the fuel to an engine 200; a pump 130 provided in the fuel transferring pipe 120 to transfer the fuel received in the receiving part 110 to the engine 200; a supplying part 140 connected to the receiving part 110 to supply the fuel in the fuel tank 300 into the receiving part 110; a measuring part 150 measuring an amount of the fuel received in the receiving part 110; a filter 160 provided in a sucking part position of the pump 130 and filtering foreign materials; and a pre-filter 170 disposed and formed to receive the supplying part 140 therein.

The pre-filter 170 may be formed so that a minimum particle size capable of being filtered in the pre-filter 170 is relatively larger than a minimum particle size capable of being filtered in the filter 160.

The pre-filter 170 may be provided so as to be attachable to and detachable from the reservoir 100.

Other features and aspects will be apparent from the following detailed description, the drawings, and the claims.

### BRIEF DESCRIPTION OF THE DRAWINGS

FIG. 1 is a view showing a reservoir for a general fuel tank;

FIG. 2 is a view showing a reservoir for a fuel tank according to the related art; and

FIG. 3 is a view showing a reservoir for a fuel tank according to an exemplary embodiment of the present invention.

[Detailed Description of Main Elements]

| | |
|---|---|
| 100: Reservoir | 110: Receiving Part |
| 120: Fuel transferring pipe | 130: Pump |
| 140: Supplying part | 150: Measuring Part |
| 160: Filter | 170: Pre-filter |
| 200: Engine | 300: Fuel Tank |

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments will be described in detail with reference to the accompanying drawings.

Hereinafter, a reservoir for a fuel tank according to an exemplary embodiment of the present invention having the above-mentioned configuration will be described in detail with reference to the accompanying drawings.

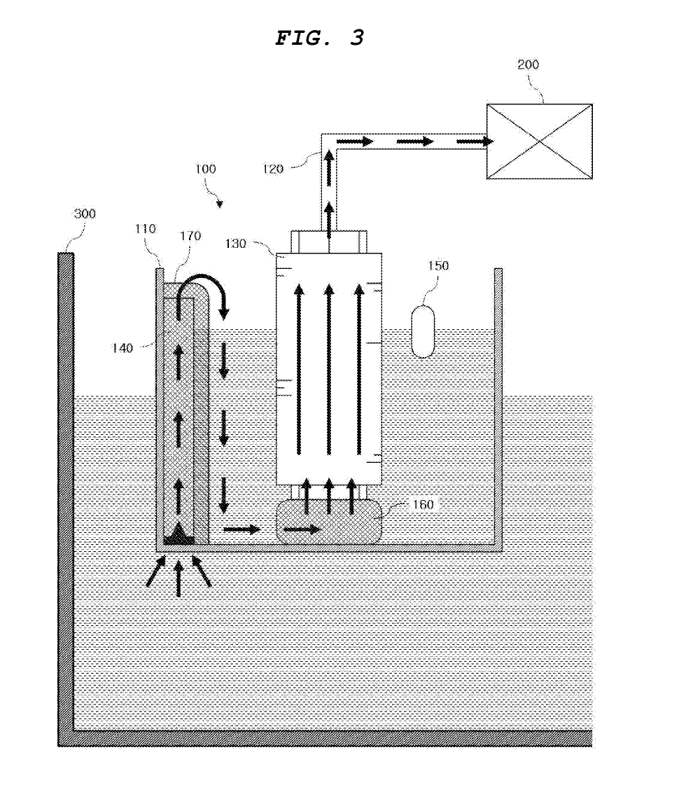

FIG. 3 shows a reservoir for a fuel tank according to an exemplary embodiment of the present invention. A basic form of a reservoir 100 according to an exemplary embodiment of the present invention is the same as the reservoir according to the related art. That is, the reservoir 100 is basically provided in a fuel tank 300 and is configured to include: a receiving part 110 having a fuel transferring pipe 120 connected thereto and receiving fuel, the fuel transferring pipe 120 transferring the fuel to an engine 200; a pump 130 provided in the fuel transferring pipe 120 to transfer the fuel received in the receiving part 110 to the engine 200; a supplying part 140 connected to the receiving part 110 to supply the fuel in the fuel tank 300 into the receiving part 110; and a measuring part 150 measuring an amount of the fuel received in the receiving part 110. Also in the reservoir 100 according to the exemplary embodiment of the present invention, the supplying part 140 may include at least one jet pump (according to a shape of the fuel tank 300) and further include another structure. For example, the supplying part 140 may further include a channel coupled thereto, wherein the channel discharges fuel returned from the engine 200.

Here, the reservoir 100 according to the exemplary embodiment of the present invention is characterized in that it is configured to include a filter 160 provided in a sucking part position of the pump 130 and filtering foreign materials and a pre-filter 170 disposed and formed to receive the supplying part 140 therein. That is, the reservoir 100 according to the exemplary embodiment of the present invention filters the foreign materials of the fuel sucked into the pump 130 using the filter 160. In addition, the fuel is primarily filtered using the pre-filter 170 before the fuel passes through the filter 160.

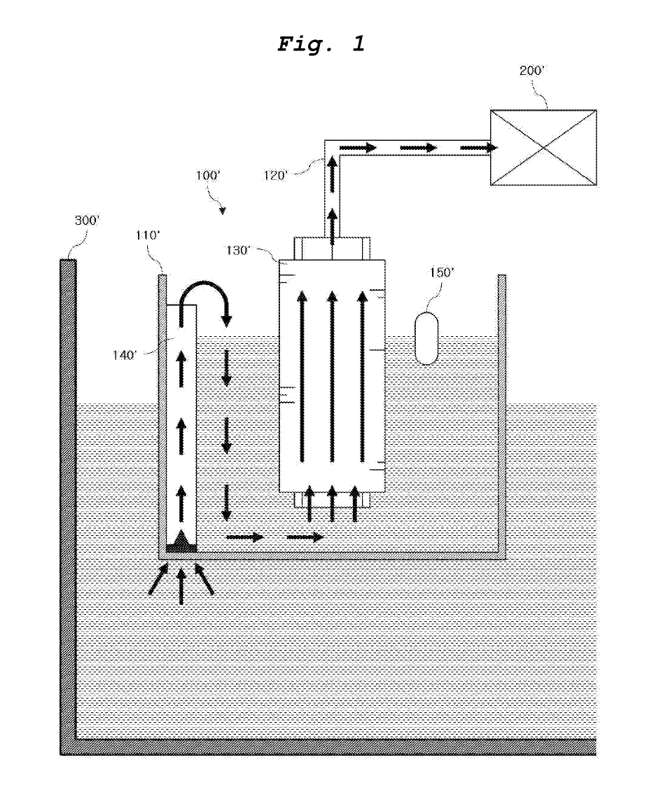

A flow of the fuel will be described below. A basic reservoir 100′ that does not include the filter 160 and the pre-filter 170 according to the exemplary embodiment of the present invention, that is, a reservoir 100′ shown in FIG. 1 will be described. Fuel received in the fuel tank 300′ is first supplied into the receiving part 110′ of the reservoir 100′ through the supplying part 140′. The fuel received in the receiving part 110′ is sucked by the pump 130′ and is supplied to the engine 200′ through the fuel transferring pipe 120′

Here, particularly in the case in which the fuel is diesel, foreign materials or solidification materials, or the like, due to a low temperature are present in the fuel in a state in which they are mixed with the fuel. In the case in which these foreign materials, or the like, are directly supplied to the engine 200′, fuel efficiency may be deteriorated or an operation defect may occur. Further, in the case in which the fuel transferring pipe 120′ or the sucking part of the pump 130 is blocked due to the foreign materials, or the like, the fuel may not be smoothly supplied to the engine 200′. In this case, the fuel transferring pipe 120′ or the pump 130′ should be cleaned or replaced, such that a large amount of time and cost are required.

Here, as shown in FIG. 3, according to the exemplary embodiment of the present invention, the filter 160 is provided in the sucking part of the pump 130 and the pre-filter 170 enclosing the supplying part 140 is provided, such that the foreign materials are filtered twice. That is, describing a flow of the fuel in the present invention, when the fuel is sucked through the supplying part 140, the fuel first passes through the pre-filter 170, such that the foreign materials, or the like, are primarily filtered. Then, the fuel again passes through the filter 160 during a process in which the fuel is sucked into the sucking part of the pump 130, such that the foreign materials are secondarily filtered. The fuel in which the foreign materials are filtered twice is introduced into the pump 130. As described above, the fuel is filtered twice, such that clean fuel not having the foreign materials may be introduced into the engine 200 through the fuel transferring pipe 120.

As described above, since the fuel is primarily filtered while passing through the pre-filter 170 and is secondarily filtered while passing through the filter 160, it is preferable that the pre-filter 170 is formed so that a minimum particle size capable of being filtered in the pre-filter 170 is relatively larger than a minimum particle size capable of being filtered in the filter 160. That is, large particles are first filtered in the pre-filter 170 and relatively small particles are then filtered in the filter 160, such that double filtering may be effectively performed.

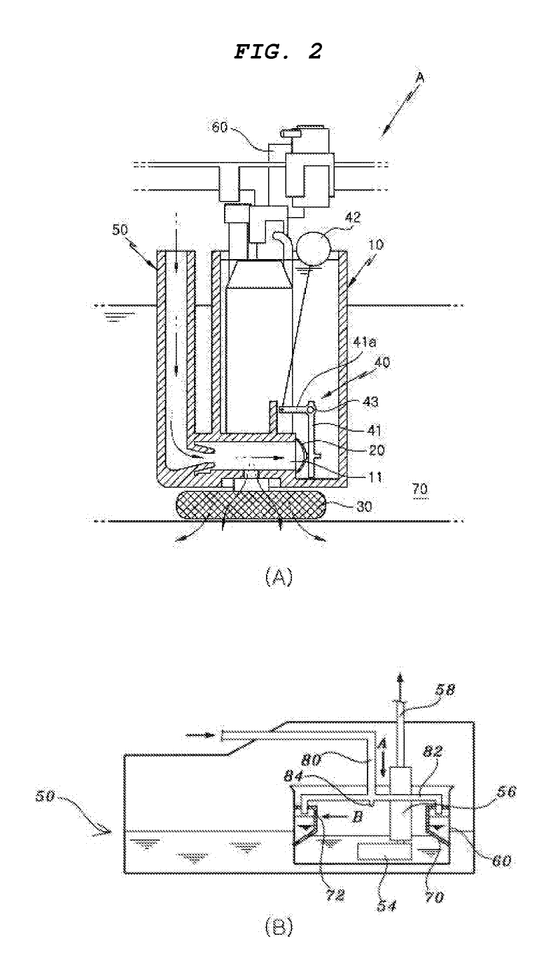

Particularly, another advantage of the present invention will be described below in detail. In the case of the related arts shown in FIG. 2, since only the filter corresponding to the filter 160 according to the exemplary embodiment of the present invention is used, the following problems occur. In the case in which only the filter 160 is present, the foreign materials are filtered only by the filter 160, the foreign materials are concentratedly accumulated in the filter 160. Therefore, when an amount of the foreign materials accumulated in the filter 160 excessively increases, the pump 130 excessively consumes energy in order to suck the fuel through the blocked filter 160 or the filter 160 having a state in which it is almost blocked. Further, in order to solve this problem, the filter 160 needs to be cleaned or replaced. However, since the filter 160 is installed in the sucking part position of the pump 130, that is, in a narrow space between the pump 130 and the bottom of the receiving part 110 as shown, a working space is significantly narrow and the disassembly and assembly is also difficult, such that a large amount of time and cost may be consumed to clean or replace the filter 160.

However, the fuel tank reservoir according to the exemplary embodiment of the present invention uses the pre-filter 170 as well as the filter 160, thereby making it possible to solve these problems. The pre-filter 170 is disposed so as to enclose the supplying part 140 as shown, that is, in a form in which it receives the supplying part 140 therein. Here, the pre-filter 170 is naturally provided so as to be attachable to and detachable from the reservoir 100. As seen from a position, a shape, or the like, of the pre-filter 170, since the pre-filter 170 has only to be formed to enclose the supplying part 140, it is simple to manufacture the pre-filter 170 and it is very easy to assemble or disassemble the pre-filter 170 to or from the reservoir 100. For example, the pre-filter 170 may be manufactured in a case shape and then coupled to the receiving part 110 by a bolt. Alternatively, taps may be formed on wall and bottom surfaces of the receiving part 110 and an edge of the pre-filter 170 may be fitted into and coupled the taps. That is, in the pre-filter 170, a structure that is conveniently attached and detached and is very simple may be easily used. In addition, since a working space is wide and a field of view is easily secured at a position at which the pre-filter 170 is provided as compared to a position at which the filter 160 is provided, the disassembly and assembly work, or the like, is significantly easily performed at the position at which the pre-filter 170 is provided, such that a time and a cost may be significantly saved.

That is, the pre-filter 170 is provided, such that the foreign materials having a relative large particle size are primarily filtered in the pre-filter 170, thereby making it possible to effectively filter the foreign materials. In addition, even though the pre-filter 170 is blocked due to an increase in an accumulated amount of the foreign materials, the pre-filter 170 is easily cleaned or replaced, thereby making it possible to significantly reduce a time and a cost required to clean or replace the pre-filter 170. Therefore, a time in which the foreign materials may be accumulated until the filter 160 needs to be cleaned or replaced significantly increases, thereby making it possible to significantly increase a lifespan of the filter 160.

In addition, as described above, since the pre-filter 170 may be manufactured in a very simple structure, the pre-filter 170 may be significantly flexibly applied to existing reservoirs having various shapes. As described above, according the exemplary embodiment of the present invention, the structure of the present invention may be easily used in an existing reservoir without newly designing a reservoir.

According to the exemplary embodiment of the present invention, in the reservoir provided in the fuel tank, the pre-filter is provided in the vicinity of the supplying part supplying the fuel into the reservoir, thereby making it possible to prevent a problem, or the like, that the foreign materials are introduced into the pump transferring the fuel to the engine to block the pump. Even though a structure in which the filter is provided in the vicinity of the sucking part of the pump is disclosed in the related art, the pre-filter according to the exemplary embodiment of the present invention is additionally provided, thereby making it possible to effectively filter the foreign materials.

Particularly, according to the exemplary embodiment of the present invention, the following advantages may be provided. In the case of the filter (provided in the pump) according to the related art, it is difficult to replace or clean the filter due to a structure or a position thereof, such that in the case in which the filter is blocked due to the accumulation of the filtered foreign materials, the fuel is unstably supplied to the engine. However, according to the exemplary embodiment of the present invention, the fuel is sucked into the pump after the foreign materials therein are primarily filtered by the pre-filter, thereby making it possible to significantly increase a lifespan of the filter provided in the pump. In addition, according to the exemplary embodiment of the present invention, since the pre-filter may be easily attached and detached and replaced, in the case in which the fuel is not smoothly supplied to the reservoir due to the accumulation of a large amount of foreign materials in the pre-filter, the pre-filter has only to be replaced or pulled out, cleaned, and then assembled again, thereby making it possible to significantly reduce a maintenance time and cost of a vehicle.

Further, the pre-filter according to the exemplary embodiment of the present invention has a simple structure, such that it may be easily manufactured. Therefore, the pre-filter has high compatibility. That is, the pre-filter may be flexibly applied to existing reservoirs having various shapes. Furthermore, due to these advantages, productivity and economical efficiency are excellent.

The present invention is not limited to the above-mentioned exemplary embodiments but may be variously applied, and may be variously modified by those skilled in the art to which the present invention pertains without departing from the gist of the present invention claimed in the claims.

What is claimed is:

1. A reservoir 100 for a fuel tank 300, the reservoir comprising:
a receiving part 110 having a fuel transferring pipe 120 connected thereto and receiving fuel, the fuel transferring pipe 120 transferring the fuel to an engine 200;
a pump 130 provided in the fuel transferring pipe 120 to transfer the fuel received in the receiving part 110 to the engine 200;
a supplying part 140 connected to the receiving part 110 to supply the fuel in the fuel tank 300 into the receiving part 110;
a measuring part 150 measuring an amount of the fuel received in the receiving part 110;
a filter 160 provided in a sucking part position of the pump 130 and filtering foreign materials; and
a pre-filter 170 disposed and formed to receive the supplying part 140 therein.

2. The reservoir of claim 1, wherein the pre-filter 170 is formed so that a minimum particle size capable of being filtered in the pre-filter 170 is relatively larger than a minimum particle size capable of being filtered in the filter 160.

3. The reservoir of claim 1, wherein the pre-filter 170 is provided so as to be attachable to and detachable from the reservoir 100.
